(19) United States
(12) Patent Application Publication
(10) Pub. No.: US 2024/0320482 A1
(43) Pub. Date: Sep. 26, 2024

(54) TRANSFORMER NETWORK WITH NORMALIZATION INCLUDING SCALING PARAMETER

(71) Applicant: Microsoft Technology Licensing, LLC, Redmond, WA (US)

(72) Inventors: Shuming MA, Beijing (CN); Li DONG, Beijing (CN); Shaohan HUANG, Beijing (CN); Dongdong ZHANG, Beijing (CN); Furu WEI, Beijing (CN); Hongyu WANG, Beijing (CN)

(73) Assignee: Microsoft Technology Licensing, LLC, Redmond, WA (US)

(21) Appl. No.: 18/176,037

(22) Filed: Feb. 28, 2023

(51) Int. Cl. G06N 3/08; G06N 3/0455; G06N 3/0499

(52) U.S. Cl. CPC G06N 3/08; G06N 3/0455; G06N 3/0499

(57) ABSTRACT

A computing system is provided, including a processor configured to receive a training data set. Based at least in part on the training data set, the processor is further configured to train a transformer network that includes a plurality of layers. The plurality of layers each respectively include a plurality of sub-layers including an attention sub-layer, a feed-forward sub-layer, and a plurality of normalization sub-layers. The plurality of normalization sub-layers are downstream from corresponding sub-layers of the plurality of sub-layers. Each of the plurality of normalization sub-layers is configured to apply layer normalization to a sum of: a first scaling parameter multiplied by an input vector of the sub-layer; and an output vector of the sub-layer.

### BACKGROUND

In recent years, transformer networks have become one of the most frequently used types of machine learning model architecture. Transformer architectures utilize attention mechanisms that map queries to key-value pairs. In addition, transformer networks typically include linear sub-networks. Compared to other types of machine learning models such as convolutional neural networks and recurrent neural networks, transformer networks may have lower computational complexity per layer and may be more efficient to implement at the hardware level. In addition, compared to other architectures, transformer architectures may allow long-range dependencies between portions of the model's input to be learned more easily. The above advantages of transformer networks have led machine learning practitioners to use transformer architectures for large-scale machine learning models.

### SUMMARY

According to one aspect of the present disclosure, a computing system is provided, including a processor configured to receive a training data set. Based at least in part on the training data set, the processor is further configured to train a transformer network that includes a plurality of layers. The plurality of layers each respectively include a plurality of sub-layers including an attention sub-layer, a feed-forward sub-layer, and a plurality of normalization sub-layers. The plurality of normalization sub-layers are downstream from corresponding sub-layers of the plurality of sub-layers. Each of the plurality of normalization sub-layers is configured to apply layer normalization to a sum of: a first scaling parameter multiplied by an input vector of the sub-layer; and an output vector of the sub-layer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system including a processor configured to implement a transformer, according to one example embodiment.

FIG. 2 schematically shows a first normalization sub-layer included in a layer of the transformer network, according to the example of FIG. 1.

FIG. 3 schematically shows training of the transformer network during an initialization phase, a warm-up phase, and a main training phase, according to the example of FIG. 1.

FIG. 4 schematically shows an attention sub-layer included in a layer of the transformer network, according to the example of FIG. 1.

FIG. 5 schematically shows a feed-forward sub-layer included in a layer of the transformer network, according to the example of FIG. 1.

FIG. 6 schematically shows the computing system when the processor performs inferencing at the transformer network subsequently to training, according to the example of FIG. 1.

FIG. 7 schematically shows the transformer network when the transformer network has an encoder-decoder architecture, according to the example of FIG. 1.

FIG. 8 schematically depicts the transformer network when the transformer network includes an encoder without including a decoder, according to the example of FIG. 1.

FIG. 9 schematically depicts the transformer network when the transformer network includes a decoder without including an encoder, according to the example of FIG. 1.

FIG. 10 schematically depicts computation of a first scaling parameter and a second scaling parameter that are used when training the transformer network, according to the example of FIG. 1.

FIG. 11A shows a flowchart of a method for use with a computing system to train a transformer network, according to the example of FIG. 1.

FIG. 11B shows additional steps of the method of FIG. 11A that may be performed to compute a first scaling parameter and a second scaling parameter.

FIG. 11C shows additional steps of the method of FIG. 11A that may be performed subsequently to training the transformer network.

FIG. 12 shows a schematic view of an example computing environment in which the computing system of FIG. 1 may be instantiated.

### DETAILED DESCRIPTION

High layer counts may allow a transformer network to model its training data in greater detail and to apply more complex functions to inputs received during inferencing. An increased layer count may allow thereby the transformer network to exhibit more sophisticated behavior, which makes increasing the layer count an attractive target for efforts to enhance the capabilities of transformer networks through further scaling.

Training instability is a difficulty that may occur when scaling transformer networks to large numbers of layers. When a transformer network experiences training instability, small changes in the training data lead to divergence in the behavior of the trained network. Training instability may, for example, result from large model updates at the beginning of training that place the transformer network near a local minimum of the transformer network's loss landscape. Subsequently to this initial update, the sizes of updates to the model may sharply decrease, leaving the network stuck in the local minimum. Accordingly, the transformer network may fail to learn its intended behavior. In addition, the specific local minimum that the network reaches at the beginning of training may vary depending on the initial weights of the network and on noise in estimated gradients computed during stochastic gradient descent.

The layers of existing transformer networks typically include LayerNorm functions. LayerNorm recenters and rescales an input vector x as follows:

$$h = g ⊙ N ( x ) + b$$

$$N ( x ) = \frac{x - μ}{σ}$$

$$μ = \frac{1}{H} {\sum }_{i = 1}^{H} {x}_{i}$$

$$σ = \sqrt{\frac{1}{H} {\sum }_{i = 1}^{H} {( {x}_{i} - μ )}^{2}}$$

In the above equations, h is the output of the LayerNorm function, ⊙ is the dot product operation, μ is the mean of the elements xᵢ of the input vector x, σ is the standard deviation of the elements xᵢ, H is the dimension of x, g is a gain vector with dimension H, and b is a bias vector with dimension H. The respective elements of the gain vector g and the bias vector b may be updated during training of the network.

As discussed in further detail below, the behavior of the conventional LayerNorm function results in the training instability discussed above in transformer networks that include large numbers of layers. The norm of the model update may be computed as:

$$‖ Δ F ‖ = ‖ F ( x , {θ}_{i} ) - F ( x , {θ}_{0} ) ‖$$

In the above equation, F is the function applied by the transformer network, x is an input vector, and θᵢ denotes the model parameters of the transformer network after i updates. In addition, the magnitude of the gradient through the LayerNorm function is given by the following:

$$‖ \frac{\partial LN ( x )}{\partial x} ‖ = 𝒪 ( \frac{\sqrt{d}}{‖ x ‖} )$$

where d is the dimensionality of the input vector x of the LayerNorm function LN(x).

Existing transformer networks include residual connections by which a copy of the input to a layer or sub-layer is made available to a subsequent layer or sub-layer. The residual connections of a series of layers or sub-layers accordingly form a residual stream that may act as working memory during processing of an input vector. In some transformer networks, the residual connections are provided to subsequent layers or sub-layers prior to applying the LayerNorm function. In such configurations, known as pre-LN, the residual copy of the input vector of a sub-layer is added to the output vector of the sub-layer to obtain the input to the LayerNorm function. In other configurations, known as post-LN, the residual copy of the input vector is added to the output of the LayerNorm function.

When post-LN residual connections are used, the transformer network may exhibit the training instability discussed above when ∥x∥>>\sqrt{d} in early training iterations. The magnitude of the gradient

$$‖ \frac{\partial LN ( x )}{\partial x} ‖$$

through the LayerNorm function is high during such iterations, thereby producing training instability.

Transformer networks that utilize pre-LN residual connections typically have greater training stability than transformer networks that utilize post-LN residual connections. However, when a pre-LN transformer architecture is used, the gradients at lower layers trend are typically smaller in average size at lower layers than at higher layers. The small sizes of the gradients at low layers degrade the performance of transformer networks with pre-LN residual connections.

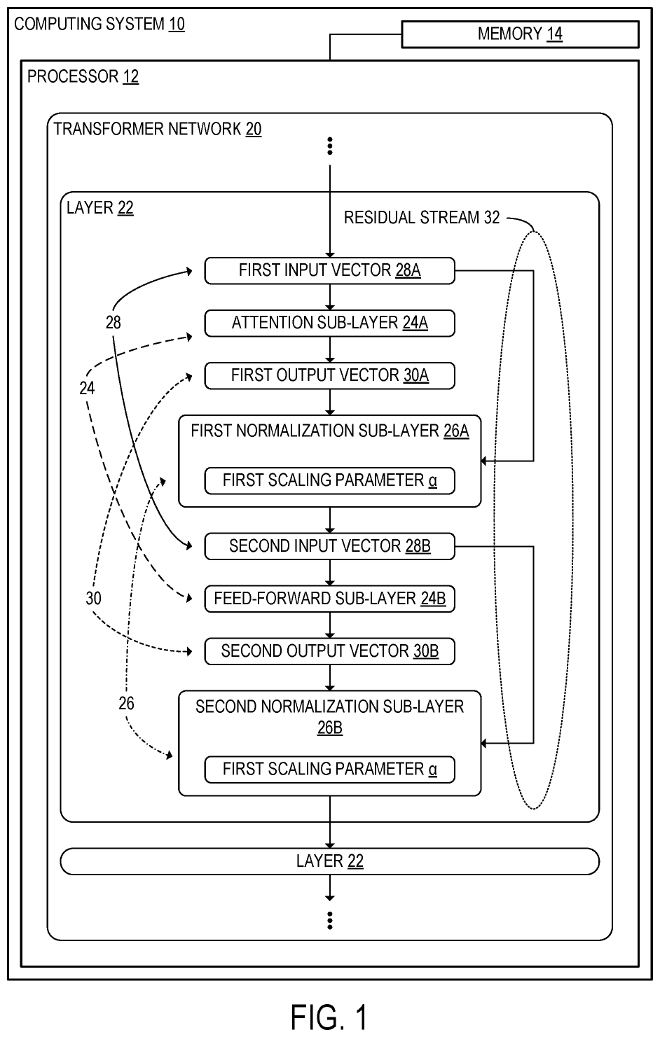

In order to address the above challenges associated with scaling transformer networks to high layer counts, a computing system 10 is provided, as depicted schematically in the example of FIG. 1. The computing system 10 shown in FIG. 1 includes a processor 12 and memory 14. The processor 12 may be instantiated as a single processing device or a plurality of processing devices, which may, for example, include one or more central processing units (CPUs), one or more graphics processing units (GPUs), and/or one or more other hardware accelerators. The memory 14 may be instantiated as a single memory device or a plurality of memory devices. The memory 14 may, for example, include one or more volatile memory devices and one or more non-volatile memory devices.

In some examples, the functionality of the computing system 10 may be distributed across a plurality of physical computing devices rather than implemented at a single computing device. For example, the computing system 10 may include a plurality of networked physical computing devices located in a data center.

As shown in FIG. 1, the processor 12 is configured to execute a transformer network 20 that includes a plurality of layers 22. In addition, the plurality of layers 22 each respectively include a plurality of sub-layers 24. The plurality of sub-layers 24 include an attention sub-layer 24A and a feed-forward sub-layer 24B. Each of the attention sub-layer 24A and the feed-forward sub-layer 24B is configured to receive a respective input vector 28 and generate a respective output vector 30. The attention sub-layer 24A is configured to receive a first input vector 28A and generate a first output vector 30A, and the feed-forward sub-layer 24B is configured to receive a second input vector 28B and generate a second output vector 30B. The first input vector 28A may be the input to the layer 22 from a previous layer 22 or a pre-processing stage.

The plurality of sub-layers 24 further include a plurality of normalization sub-layers 26 located downstream from corresponding sub-layers 24 of the plurality of sub-layers 24. The layer 22 depicted in the example of FIG. 1 includes a first normalization sub-layer 26A located downstream from the attention sub-layer 24A and a second normalization sub-layer 26B located downstream from the feed-forward sub-layer 24B.

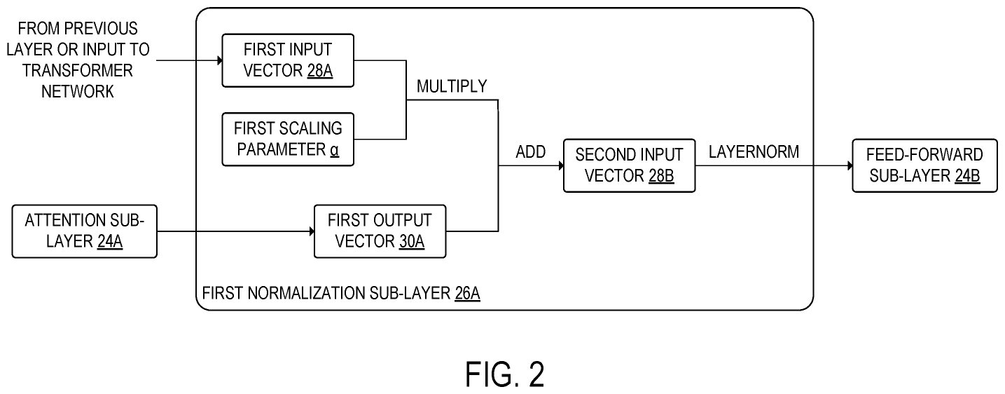

FIG. 2 shows the first normalization sub-layer 26A in additional detail, according to the example of FIG. 1. Each of the plurality of normalization sub-layers 26 is configured to apply layer normalization to a sum of: a first scaling parameter α multiplied by the input vector 28 of the sub-layer 24; and the output vector of the sub-layer 24. Accordingly, the normalization sub-layer 26 applies the following function:

$${x}_{l + 1} = LN ( α {x}_{l} + {G}_{l} ( {x}_{l} , {θ}_{l} ) )$$

In the above equation, the normalization sub-layer 26 is downstream of an lth non-normalization sub-layer (the attention sub-layer 24A or the feed-forward sub-layer 24B). xₗ₊₁ is the output vector of the normalization sub-layer 26, and xₗ is the input vector of the sub-layer 24 preceding the normalization sub-layer 26. θₗ are the weights of the preceding sub-layer 24 and Gₗ is the function applied by the preceding sub-layer 24. LN is the LayerNorm function.

As depicted in the example of FIG. 1, the copies of the input vectors 28 that are input into the normalization sub-layers 26 form a residual stream 32. The residual stream 32 acts as working memory of the transformer network 20 by allowing sub-layers 24 to utilize copies of information received at earlier sub-layers 24. At the first layer 22 included in the transformer network 20, the first input vector 28A is the input to the transformer network 20, subsequently to pre-processing.

The first scaling parameter α has the effect of scaling the copies of the input vectors 28 passed to the normalization sub-layers 26 in the residual stream 32, thereby weighting respective contributions of xₗ and Gₗ(xₗ, θₗ) to the input vectors 28 of subsequent sub-layers 24. Although, in the above equation, the input vector xₗ is scaled by the first scaling parameter α, the output vector Gₗ(xₗ, θₗ) may instead be scaled by a scaling parameter equal to 1/α to achieve equivalent behavior of the normalization sub-layer 26.

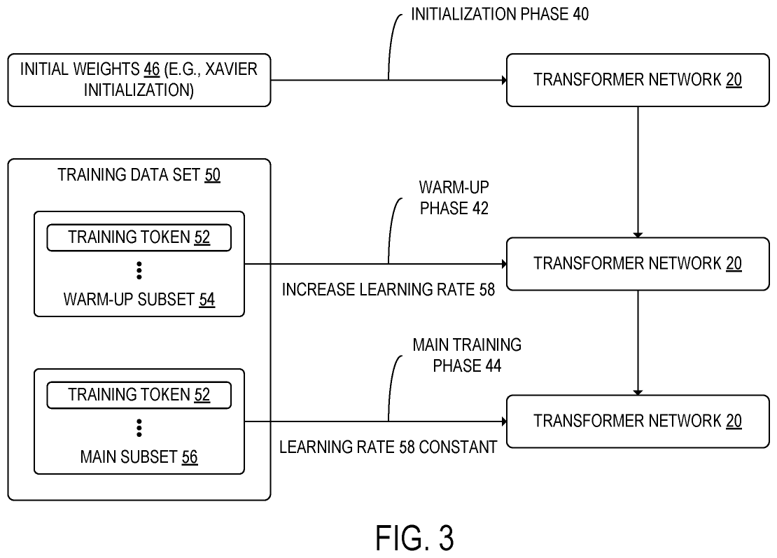

FIG. 3 schematically shows training of the transformer network 20. The training includes an initialization phase 40, a warm-up phase 42, and a main training phase 44. In the initialization phase 40, the processor 12 is configured to set the weights of the transformer network 20 to a respective plurality of initial weights 46. For example, the processor 12 may be configured to set the initial weights via Xavier initialization, in which variance in activations is substantially uniform across the plurality of sub-layers. In addition, as discussed in further detail below, the processor 12 may be further configured to perform weight scaling during the initialization phase 40 to increase stability of the transformer network 20 during training.

The training data set 50 used to train the transformer network 20 includes a plurality of training tokens 52 that are divided into a warm-up subset 54 and a main subset 56. During the warm-up phase 42, the processor 12 is configured to train the transformer network 20 using the training tokens 52 included in the warm-up subset 54. The processor 12 is configured to gradually increase a learning rate 58 of the transformer network 20 over the course of the warm-up phase 42 until the learning rate 58 reaches a main-phase learning rate. The processor 12 is further configured to train the transformer network 20 at the main-phase learning rate using the main subset 56 of training tokens 52 during the main training phase 44.

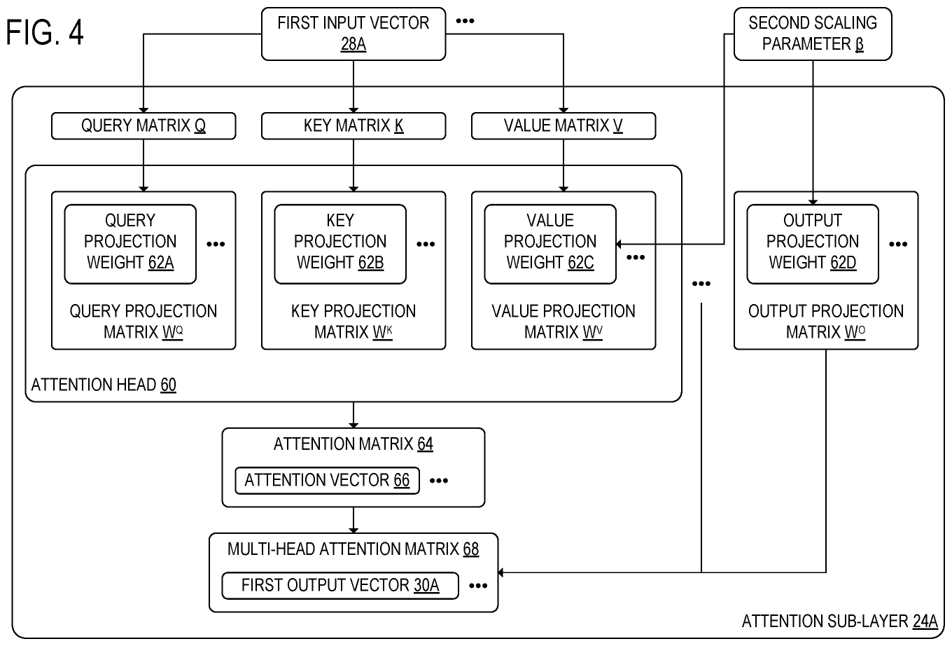

FIG. 4 schematically shows the attention sub-layer 24A in additional detail, according to one example. In the example of FIG. 3, the processor 12 is configured to process one or more first input vectors 28A concurrently at the attention sub-layer 24A. The attention sub-layer 24A may, for example, process a plurality of first input vectors 28A included in a mini-batch concurrently during training of the transformer network 20. As shown in the example of FIG. 4, the attention sub-layer 24A includes a plurality of attention heads 60 that are configured to generate respective attention matrices 64. The attention matrices 64 each include one or more attention vectors 66. At the attention sub-layer 24A, the processor 12 is further configured to compute a multi-head attention matrix 68 including one or more first output vectors 30A corresponding to the one or more attention vectors 46.

In the example of FIG. 4, the processor 12 is configured to compute a query matrix Q, a key matrix K, and a value matrix V based at least in part on the first input vector 28A. Q, K, V∈ [symbol] ^{n×d} respectively denote the query matrix, the key matrix, and the value matrix, where n is a number of one or more concurrently processed first input vectors 28A, and where d is the dimensionality of each of the one or more first input vectors 28A.

The attention head 60 includes query, key, and value projection matrices W^{Q}, W^{K}, W^{V}∈ [symbol] ^{d×d}^{ₖ}. The attention sub-layer 24A further includes an output projection matrix W^{O}∈ [symbol] ^{d}^{ₖ}^{×d}, where dₖ is the dimensionality of a projection space of the attention sub-layer 24A. The query projection matrix W^{Q} includes a plurality of query projection weights 62A, the key projection matrix W^{K} includes a plurality of key projection weights 62B, the value projection matrix W^{V} includes a plurality of value projection weights 62C, and the output projection matrix W^{O} includes a plurality of output projection weights 62D.

In an example in which the attention sub-layer 24A is a one-attention-head sub-layer, the processor 12 is further configured to compute the first output vectors 30A over the query matrix Q, the key matrix K, and the value matrix V according to the following equation:

$$Attn ( Q , K , V ) = softmax ( \frac{{{QW}^{Q} ( {KW}^{K} )}^{T}}{\sqrt{{d}_{k}}} ) {VW}^{V} {W}^{O}$$

Thus, in the above equation, each of the query matrix Q, the key matrix K, and the value matrix V is multiplied by its respective projection matrix. In the above equation, the attention vector 66 is the product of the terms on the righthand side prior to the output projection matrix W^{O}. The processor 12 is further configured to compute the first output vector 30A by multiplying the attention vector 66 by the output projection matrix W^{O}.

The one-attention-head case may be extended to a multi-headed attention case by concatenating a plurality of attention matrices 64 and multiplying the concatenated attention matrices 64 by the output projection matrix W^{O} to obtain a multi-head attention matrix 68.

FIG. 4 further shows a second scaling parameter β that is utilized when training the transformer network 20. During the initialization phase 40 depicted in FIG. 3, the processor 12 may be further configured to scale the plurality of value projection weights 62C of the value projection matrix W^{V} and the plurality of output projection weights 62D of the output projection matrix W^{O} included in the attention sub-layer 24A by the second scaling parameter β. This scaling may be performed to increase the stability of the transformer network 20 during training, as discussed above.

Scaling the query projection weights 62A of the query projection matrix W^{Q} and the key projection weights 62B of the key projection matrix W^{K} would not offer a further increase in stability, since the query projection matrix W^{Q} and the key projection matrix W^{K} are included in the input of the softmax function in the above equation for the first output vectors 30A. Given a vector X=(x₁, x₂, . . . xₙ)^{T}∈ [symbol] ^{n×d}, where var(xᵢ)=1, mean(xᵢ)=0, and qᵢ∈ [symbol] for all i∈[1, n], the softmax function has the following property:

$$softmax ( {q}_{1} , {q}_{2} , … {q}_{n} ) X {=}^{Θ} {x}_{i}$$

where =^{Θ} indicates an equal bound of a magnitude. Thus, the magnitude of Attn(Q,K,V) depends only on the value projection matrix WY and the output projection matrix W^{O}, with Attn(Q,K,V)=^{Θ}VW^{V}W^{O}.

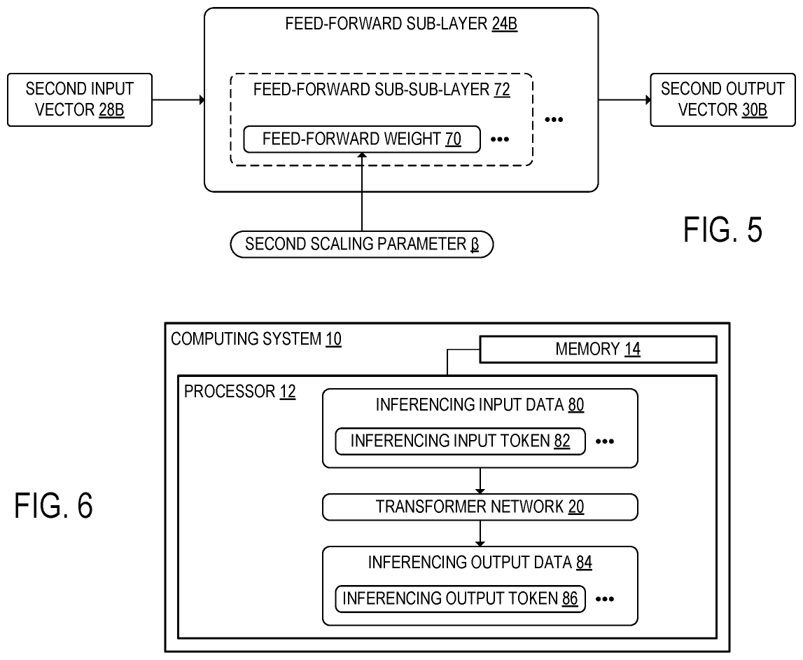

FIG. 5 schematically shows the feed-forward sub-layer 24B of FIG. 1 in additional detail. The feed-forward sub-layer 24B is configured to receive the second input vector 28B and compute a second output vector 30B. The feed-forward sub-layer 24B includes a plurality of feed-forward weights 70. In some examples, the feed-forward sub-layer 24B is a multi-layer perceptron (MLP) layer that includes a plurality of feed-forward sub-sub-layers 72, each of which includes a respective plurality of the feed-forward weights 70.

During the initialization phase 40, the processor 12 may be further configured to scale the plurality of feed-forward weights 70 of the feed-forward sub-layer 24B by the second scaling parameter β. Similarly to scaling W^{V} and W^{O}, scaling the feed-forward weights 70 by the second scaling parameter β may increase the training stability.

The magnitudes of model updates to the transformer network 20 during training are discussed below. In order to focus on the magnitude of a model update, the matrices W^{V} and W^{O} are reduced to scalars v and w in the following discussion. With this simplification, Attn(Q, K, V)=^{Θ}vwV. In addition, FFN(X)=^{Θ}vwX, where v and w are scalars corresponding to feed-forward sub-sub-layers 72 included in the feed-forward sub-layer 24B. The magnitude of the model update is defined as:

$$‖ Δ F ‖ = ‖ F ( x , {θ}^{*} ) - F ( x , θ ) ‖$$

where θ are the initial weights of the model F and θ* are the updated weights.

Bounds on the magnitude of the model update are discussed below for an N-layer transformer network F(x, θ) where θ={θ₁, θ₂, . . . , θ_{2N}} and where θ₂ₗ₋₁ and θ₂ₗ are the parameters of the attention sub-layer 24A and the feed-forward sub-layer 24B in the lth layer, respectively. At the transformer network F(x, θ), the normalization function xₗ₊₁=LN(αxₗ+Gₗ(xₗ, θₗ)) discussed above is used at each normalization sub-layer 26. The model update magnitude of the transformer network F(x, θ) has the following bound:

$$‖ Δ F ‖ \leq {\sum }_{i = 1}^{2 N} \frac{\sqrt{{v}_{i}^{2} + {w}_{i}^{2}}}{α} ‖ {θ}_{i}^{*} - {θ}_{i} ‖$$

As seen from the above inequality, initializing the model weights at smaller values increases training stability by decreasing \sqrt{vᵢ²+wᵢ²}. In addition, performing the warm-up phase 42 before the main training phase 44 increases training stability by decreasing ∥θ*ᵢ−θᵢ∥.

FIG. 6 shows the computing system 10 when the processor 12 performs inferencing at the transformer network 20 subsequently to training. The processor 12 is configured to receive inferencing input data 80. The inferencing input data 80 may be a vector of one or more inferencing input tokens 82. The processor 12 is further configured to process the inferencing input data 80 at the transformer network 20 to generate inferencing output data 84. The inferencing output data 84 may be a vector of one or more inferencing output tokens 86.

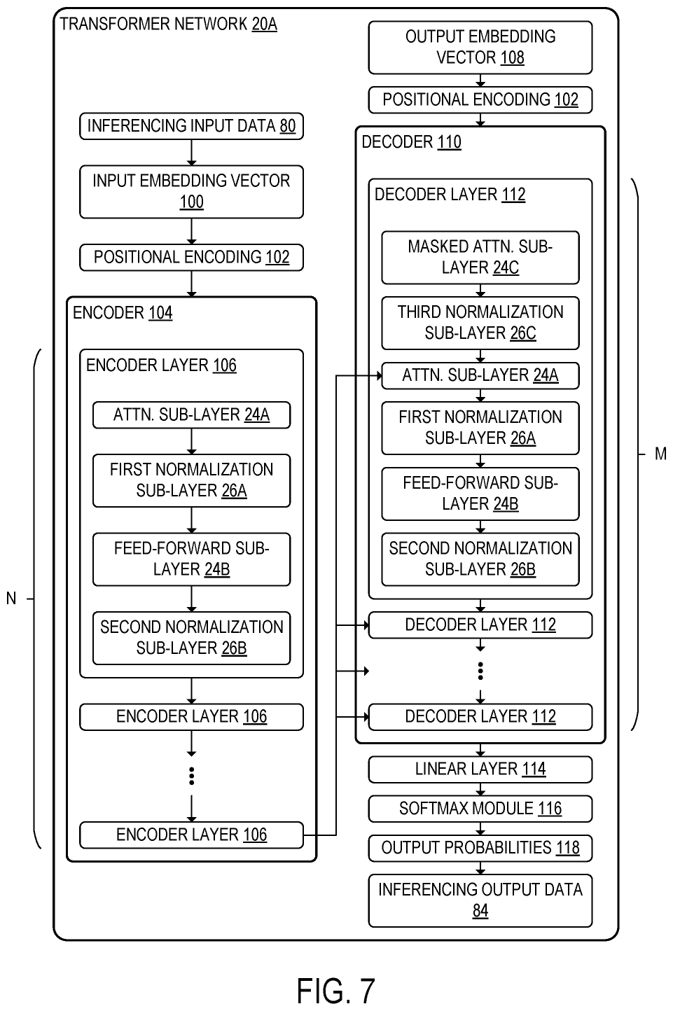

FIG. 7 schematically shows an example transformer network 20A that has an encoder-decoder architecture. In the example of FIG. 7, the transformer network 20A is shown during inferencing. The transformer network 20A is configured to receive the inferencing input data 80 and compute an input embedding vector 100 based at least in part on the inferencing input data 80. The input embedding vector 100 expresses the inferencing input tokens 82 in the form of an embedding vector. In the example of FIG. 7, the processor 12 is further configured to apply a positional encoding 102 to the input embedding vector 100. The positional encoding 102 may, for example, be a sinusoidal positional encoding added to the input embedding vector 100.

The transformer network 20A shown in the example of FIG. 7 includes an encoder 104 that includes a plurality of encoder layers 106. Each of the encoder layers 106 includes an attention sub-layer 24A, a first normalization sub-layer 26A, a feed-forward sub-layer 24B, and a second normalization sub-layer 26B. The number of encoder layers 106 is denoted as N.

The processor 12 is further configured to autoregressively compute an output embedding vector 108 by iteratively predicting a subsequent inferencing output token 86 included in the inferencing output data 84. For each inferencing output token 86 following a first inferencing output token 86, the processor 12 is configured to compute that inferencing output token 86 based at least in part on the one or more prior inferencing output tokens 86 included in the output embedding vector 108.

The processor 12 is further configured to apply a positional encoding 102 to the output embedding vector 108. Similarly to the positional encoding 102 applied to the input embedding vector 100, the positional encoding 102 applied to the output embedding vector 108 may be a sinusoidal positional encoding that is added to the output embedding vector 108.

At each iteration in which an inferencing output token 86 of the inferencing output data 84 is computed, the current version of the output embedding vector 108 with the positional encoding 102 is input into a decoder 110. The decoder 110 includes a plurality of decoder layers 112, and the number of decoder layers 112 included in the transformer network 20A is denoted by M. Each of the decoder layers 112 in the example of FIG. 7 includes an attention sub-layer 24A, a first normalization sub-layer 26A, a feed-forward sub-layer 24B, and a second normalization sub-layer 26B. However, in contrast to the encoder layers 106, each of the decoder layers 112 shown in FIG. 7 further includes a masked attention sub-layer 24C and a third normalization sub-layer 26C prior to the attention sub-layer 24A. At the masked attention sub-layer 24C, the processor 12 is configured to inhibit predictions inferencing output tokens 86 from depending on later tokens included in the inferencing output data 84. As another difference between the encoder layers 106 and the decoder layers 112, the respective attention sub-layers 24A included in the decoder layers 112 are configured to receive copies of the output of a last encoder layer 106 included in the encoder 104.

Subsequently to the decoder 110, the transformer network 20A shown in the example of FIG. 7 further includes a linear layer 114. In addition, the processor 12 is further configured to apply a softmax function to the output of the linear layer 114 at a softmax module 116. The softmax module 116 outputs a plurality of output probabilities 118 of the inferencing output tokens 86 included in the inferencing output data 84. The output probabilities 118 are predicted next-token probabilities in the example of FIG. 7. The processor 12 is further configured to select the inferencing output tokens 86 according to these output probabilities 118 to thereby construct the inferencing output data 84.

Bounds on the model update magnitude ∥ΔF_{ed}∥ of the transformer network F_{ed} with the encoder-decoder architecture are discussed below. The magnitude of the model update is defined as follows for the encoder-decoder architecture:

$$‖ Δ {F}_{ed} ‖ = ‖ {F}_{ed} ( x , y , {θ}_{e}^{*} , {θ}_{d}^{*} ) - {F}_{ed} ( x , y , {θ}_{e} , {θ}_{d} ) ‖$$

In the above equation, x and y are the inputs to the encoder 104 and the decoder 110, respectively. θₑ and θ_{d} are the corresponding initial parameters of the encoder 104 and the decoder 110, and θ*ₑ and θ*_{d} are their updated parameters. The transformer network F_{ed} includes N encoder layers 106 and M decoder layers 112. The encoder layers 106 each use the normalization function xₗ₊₁=LN(αₑxₗ+Gₑₗ(xₗ, θₑₗ), and the decoder layers 112 each use the normalization function xₗ₊₁=LN(α_{d}xₗ+G_{dl}(x₁, θ_{dl})).

When the encoder-decoder transformer network F_{ed} and its model update magnitude ∥ΔF_{ed}∥ are defined as shown above, the model update magnitude has the following bound:

$$‖ Δ {F}_{ed} ‖ \leq {\sum }_{j = 1}^{M} \frac{{v}_{d , 3 j - 1} {w}_{d , 3 j - 1}}{{α}_{d}} {\sum }_{i = 1}^{2 N} \frac{\sqrt{{v}_{ei}^{2} + {w}_{ei}^{2}}}{{α}_{e}} ‖ {θ}_{ei}^{*} - {θ}_{ei} ‖ + {\sum }_{j = 1}^{3 M} \frac{\sqrt{{v}_{dj}^{2} + {w}_{dj}^{2}}}{{α}_{d}} ‖ {θ}_{dj}^{*} - {θ}_{dj} ‖$$

In the encoder-decoder transformer network F_{ed}, since model updates are propagated from the encoder 104 to the decoder 110, the training stability of the decoder 110 is lower than that of the encoder 104.

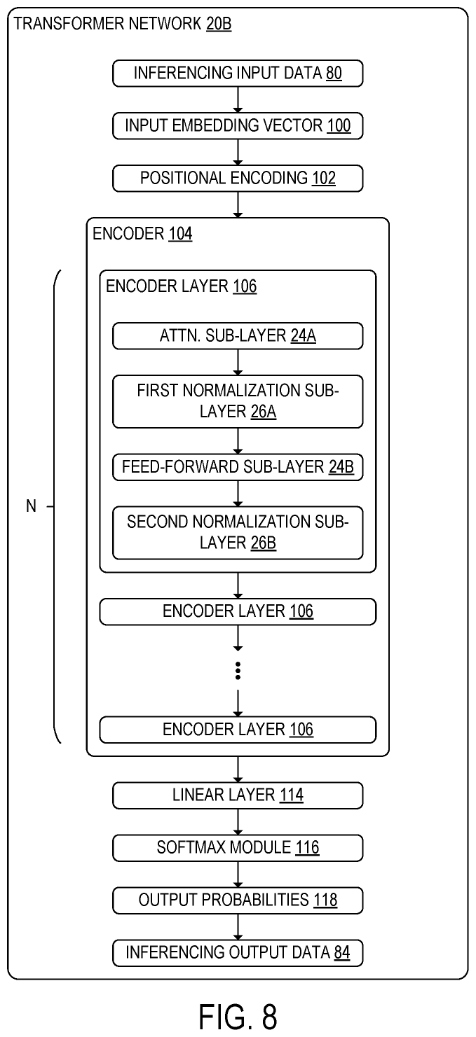

FIG. 8 schematically depicts an example transformer network 20B that includes an encoder 104 without including a decoder 110. At the transformer network 20B, the processor 12 is configured to compute an input embedding vector 100 based at least in part on the inferencing input tokens 82 included in the inferencing input data 80 and is further configured to apply a positional encoding 102 to the input embedding vector 100. The processor 12 is further configured to input the input embedding vector 100 with the positional encoding 102 into the encoder 104. The transformer network 20B of FIG. 8 includes a linear layer 114 configured to receive output from the encoder 104, as well as a softmax module 116 configured to receive output from the linear layer 114. The softmax module 116 is configured to compute output probabilities 118 of predicted subsequent tokens. The processor 12 is further configured to compute the inferencing output data 84 as specified by the output probabilities 118.

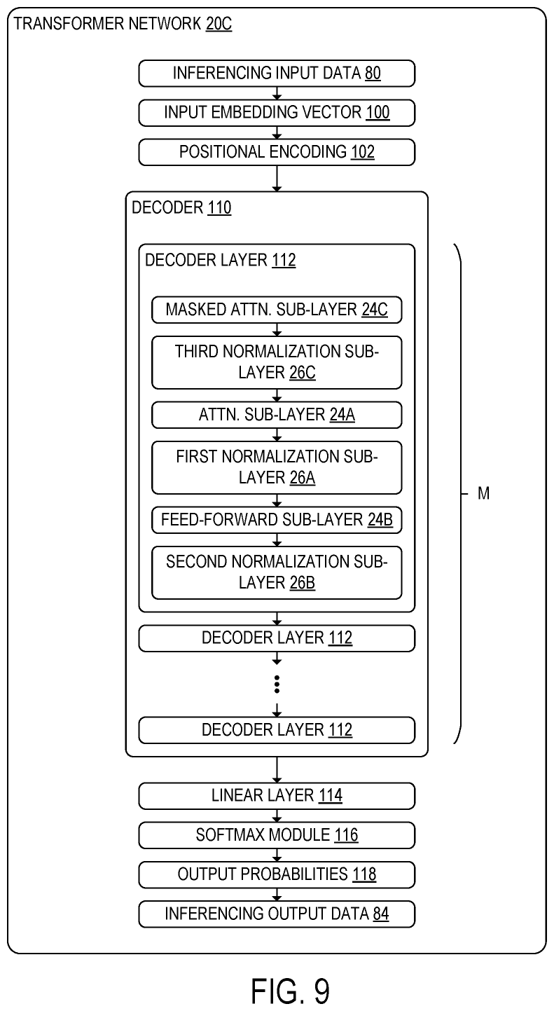

FIG. 9 schematically shows another example transformer network 20C that includes a decoder 110 without including an encoder 104. The processor 12 is configured to compute an input embedding vector 100 based at least in part on the inferencing input tokens 82 included in the inferencing input data 80 and is further configured to apply a positional encoding 102 to the input embedding vector 100. The processor 12 is further configured to input the input embedding vector 100 with the positional encoding 102 into the decoder 110. The transformer network 20C of FIG. 9 differs from the transformer network 20B of FIG. 8 in that the decoder layers 112 each include a respective masked attention sub-layer 24C followed by a third normalization layer 26C prior to the attention sub-layer 24A, the first normalization sub-layer 26A, the feed-forward sub-layer 24B, and the second normalization sub-layer 26B. The transformer network 20C of FIG. 9 further includes a linear layer 114 and a softmax module 116 following the decoder 110, and the softmax module 116 is configured to output a plurality of output probabilities 118. The processor 12 is further configured to compute the inferencing output data 84 as specified by the output probabilities 118.

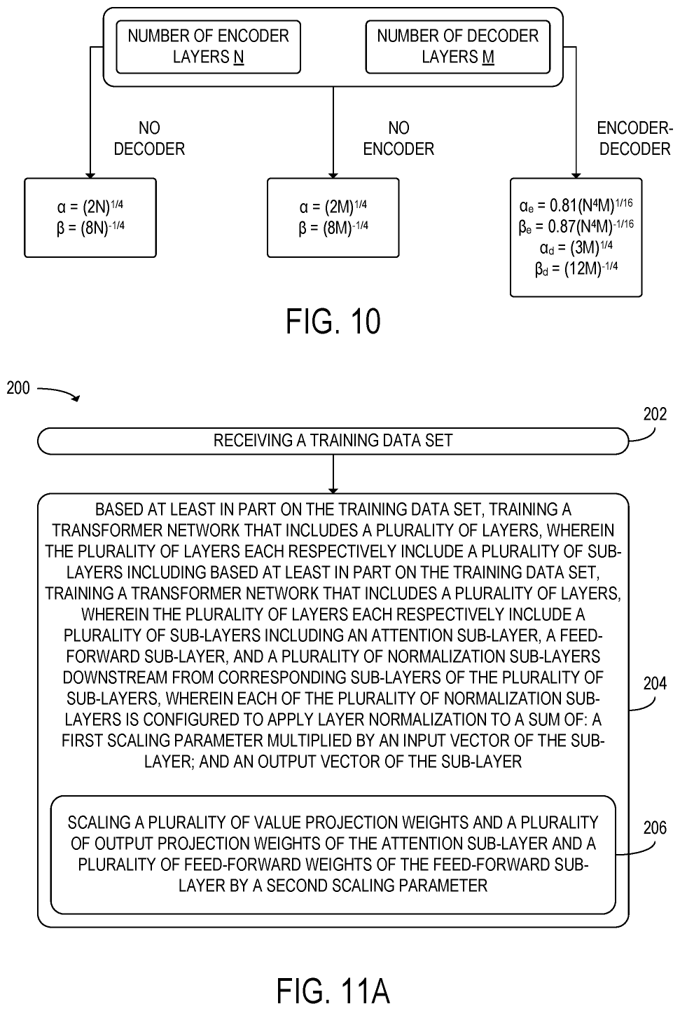

Turning now to FIG. 10, computation of the first scaling parameter α and the second scaling parameter β is schematically depicted. During the initialization phase 40, the processor 12 may be further configured to determine the first scaling parameter a and the second scaling parameter β based at least in part on a number of the plurality of layers 22 included in the transformer network 20. The processor 12 may be further configured to determine the first scaling parameter α and the second scaling parameter β based at least in part on whether or not the transformer network 20 includes both an encoder 104 and a decoder 110, as in the example of FIG. 7.

As shown in the example of FIG. 10, when the transformer network 20 includes the encoder 104 without including the decoder 110 or includes the decoder 110 without including the encoder 104, the first scaling parameter a may be equal to

$${( 2 N )}^{\frac{1}{4}} ,$$

where N is the number of the plurality of layers. In such examples, the second scaling parameter β may be equal to

$${( 8 N )}^{- \frac{1}{4}} .$$

In examples in which the transformer network 20 includes both the encoder 104 and the decoder 110, the respective values of the first scaling parameter α and the second scaling parameter β differ between the encoder 104 and the decoder 110. In such examples, the first scaling parameter at the encoder 104 is indicated as αₑ, the second scaling parameter at the encoder 104 is indicated as βₑ, the first scaling parameter at the decoder 110 is indicated as α_{d}, and the second scaling parameter at the decoder 110 is indicated as β_{d}. When the encoder-decoder architecture shown in FIG. 7 is used, the first and second scaling parameters at the encoder 104 and the decoder 110 may be set to the following values:

$${α}_{e} = 0.81 {( {N}^{4} M )}^{\frac{1}{16}}$$

$${β}_{e} = 0.87 {( {N}^{4} M )}^{\frac{- 1}{16}}$$

$${α}_{d} = {( 3 M )}^{\frac{1}{4}}$$

$${β}_{d} = {( 12 M )}^{\frac{- 1}{4}}$$

The scaling parameters for the three architectures shown in FIGS. 7-9 are summarized in the following table:

| Architecture | Encoder α | Encoder β | Decoder α | Decoder β |
|---|---|---|---|---|
| Encoder, no decoder | ${( 2 N )}^{\frac{1}{4}}$ | ${( 8 N )}^{- \frac{1}{4}}$ | — | — |
| Decoder, no encoder | — | — | ${( 2 M )}^{\frac{1}{4}}$ | ${( 8 M )}^{- \frac{1}{4}}$ |
| Encoder- decoder | $0.81 {( {N}^{4} M )}^{\frac{1}{16}}$ | $0.87 {( {N}^{4} M )}^{\frac{- 1}{16}}$ | ${( 3 M )}^{\frac{1}{4}}$ | ${( 12 M )}^{\frac{- 1}{4}}$ |

The derivations of the above values of α, β, αₑ, βₑ, α_{d}, and β_{d} are discussed below. For the encoder-decoder architecture, the transformer network F_{ed}(x, y, θₑ, θ_{d}) is updated by Θ(η) at each stochastic gradient descent step after initialization at η→0, where n is the learning rate. Accordingly, ∥ΔF_{ed}∥=Θ(η), where:

$$Δ {F}_{ed} \hat{=} {F}_{ed} ( x , y , {θ}_{e} - η \frac{\partial ℒ}{\partial {θ}_{e}} , {θ}_{d} - η \frac{\partial ℒ}{\partial {θ}_{d}} ) - {F}_{ed} ( x , y , {θ}_{e} , {θ}_{d} )$$

In the above equation, [symbol] is the value of the loss function of the transformer network F_{ed}. The update ∥θ*_{di}−θ_{di}∥ to each decoder layer 112 is equal to

$$η ‖ \frac{\partial ℒ}{\partial {θ}_{di}} ‖ .$$

Post-LN decreases the magnitude of a backpropagating error signal, thereby resulting in the following inequality:

$$‖ \frac{\partial F}{\partial {θ}_{dj}} ‖ \leq ‖ \frac{\partial F}{\partial {θ}_{d , 3 M}} ‖$$

In addition, the following quantities have magnitudes with equal bounds:

$$‖ \frac{\partial F}{\partial {θ}_{d , 3 M}} ‖ {=}^{Θ} \frac{‖ {θ}_{d , 3 M} ‖}{{α}_{d}}$$

### When

$$‖ \frac{\partial ℒ}{\partial F} ‖ = 𝒪 ( 1 ) ,$$

the second term of the model update magnitude bound on ∥ΔF_{ed}∥ is bounded as follows:

$${\sum }_{j = 1}^{3 M} \frac{\sqrt{{v}_{dj}^{2} + {w}_{dj}^{2}}}{{α}_{d}} ‖ {θ}_{dj}^{*} - {θ}_{dj} ‖ \leq η ‖ \frac{\partial ℒ}{\partial F} ‖ \cdot ‖ \frac{\partial F}{\partial {θ}_{d , 3 M}} ‖ {\sum }_{j = 1}^{3 M} \frac{\sqrt{{v}_{dj}^{2} + {w}_{dj}^{2}}}{{α}_{d}} {=}^{Θ} 3 η M \frac{{v}_{d}^{2} + {w}_{d}^{2}}{{α}_{d}^{2}}$$

In order to balance the effects of residual connections and initialization, the values

$${α}_{d}^{2} = {( 3 M )}^{\frac{1}{2}} and {v}_{d}^{2} + {w}_{d}^{2} = {( 3 M )}^{\frac{1}{2}}$$

may be used. With these values, the second term of ∥ΔF_{ed}∥ has a magnitude bounded by 3 ηM. In addition, v_{d}=w_{d}=β_{d}, since the value projection weights 62C and the output projection weights 62D included in each of the decoder layers 112 are scaled by β_{d}. Thus, the values

$${α}_{d} = {( 3 M )}^{\frac{1}{4}} and {β}_{d} = {( 12 M )}^{\frac{- 1}{4}}$$

are used for the first scaling parameter and the second scaling parameter at the decoder 110.

In the first term of the model update magnitude bound on ∥ΔF_{ed}∥, vₑᵢ=vₑ and wₑᵢ=wₑ. In addition,

$${v}_{d} = {w}_{d} = {( 12 M )}^{\frac{- 1}{4}} and {α}_{d} = {( 3 M )}^{\frac{1}{4}}$$

as discussed above. Accordingly, the first term is equal to:

$${\sum }_{j = 1}^{M} \frac{{v}_{d , 3 j - 1} {w}_{d , 3 j - 1}}{{α}_{d}} {\sum }_{i = 1}^{2 N} \frac{\sqrt{{v}_{ei}^{2} + {w}_{ei}^{2}}}{{α}_{e}} ‖ {θ}_{ei}^{*} - {θ}_{ei} ‖ = M \frac{{( 12 M )}^{\frac{- 1}{2}}}{{( 3 M )}^{\frac{1}{4}}} {\sum }_{i = 1}^{2 N} \frac{\sqrt{{v}_{ei}^{2} + {w}_{ei}^{2}}}{{α}_{e}} ‖ {θ}_{ei}^{*} - {θ}_{ei} ‖ {=}^{Θ} {η ( \frac{{N}^{4} M}{27} )}^{\frac{1}{4}} \frac{{v}_{e}^{2} + {w}_{e}^{2}}{{α}_{e}^{2}}$$

Thus, the effects of residual connections and initialization may be balanced by setting

$${α}_{e}^{2} = {( {N}^{4} M / 27 )}^{\frac{1}{8}} , {v}_{e}^{2} + {w}_{e}^{2} = {( {N}^{4} M / 27 )}^{- \frac{1}{8}} , and {v}_{e} = {w}_{e} = {β}_{e} .$$

This results in the values

$${α}_{e} = 0.81 {( {N}^{4} M )}^{\frac{1}{16}} and {β}_{e} = 0.87 {( {N}^{4} M )}^{\frac{- 1}{16}}$$

for the first and second scaling parameters at the encoder 104.

In examples in which the transformer network 20 includes an encoder 104 without a decoder 110 or a decoder 110 without an encoder 104, as respectively shown in FIGS. 8 and 9, the values of the first scaling parameter α and the second scaling parameter β may be derived as follows. For a transformer network 20 with N layers, the following inequality holds:

$$‖ {x}_{2 N + 1}^{*} - {x}_{2 N + 1} ‖ \leq {\sum }_{i = 1}^{2 N} \frac{\sqrt{{v}_{i}^{2} + {w}_{i}^{2}}}{α} ‖ {θ}_{i}^{*} - {θ}_{i} ‖ \leq η {\sum }_{i = 1}^{2 N} \frac{\sqrt{{v}_{i}^{2} + {w}_{i}^{2}}}{α} ‖ \frac{\partial ℒ}{\partial F} ‖ \cdot ‖ \frac{\partial F}{\partial {θ}_{i}} ‖$$

By assumption, as discussed above,

$$‖ \frac{\partial ℒ}{\partial F} ‖ = 𝒪 ( 1 ) .$$

In addition:

$$‖ \frac{\partial F}{\partial {θ}_{i}} ‖ \leq ‖ \frac{\partial F}{\partial {θ}_{2 N}} ‖ {=}^{Θ} \frac{‖ {θ}_{2 N} ‖}{α}$$

These relationships result in the following inequality:

$${\sum }_{i = 1}^{2 N} \frac{\sqrt{{v}_{i}^{2} + {w}_{i}^{2}}}{α} ‖ \frac{\partial ℒ}{\partial F} ‖ \cdot ‖ \frac{\partial F}{\partial {θ}_{i}} ‖ \leq 𝒪 ( \frac{\sqrt{{v}_{2 N}^{2} + {w}_{2 N}^{2}}}{α} {\sum }_{i = 1}^{2 N} \frac{\sqrt{{v}_{i}^{2} + {w}_{i}^{2}}}{α} ) = 𝒪 ( 1 )$$

Since the value projection weights 62C and the output projection weights 62D included in each of the attention sub-layers 24A are scaled by β, vᵢ=v and wᵢ=w. Accordingly,

$$2 N \frac{{v}^{2} + {w}^{2}}{{α}^{2}} = 1.$$

The scaling parameter values

$$v = w = {( 8 N )}^{- \frac{1}{4}} and α = {( 2 N )}^{\frac{1}{4}}$$

satisfy this equation, and, as above, v=w=β. The above derivation holds for both the transformer network 20B of FIG. 8 and the transformer network 20C of FIG. 9.

The above architecture that utilizes the first scaling parameter α and the second scaling parameter β allows the number of layers 22 in the transformer network 20 to be increased while maintaining stability during training of the transformer network 20. For example, the transformer network 20 may include 100 or more layers 22. In other examples, the number of layers 22 may be increased further, such as to 200 layers, 500 layers, or 1000 layers. The ability of the transformer network 20 to exhibit complex behavior, model phenomena in detail, and find solutions to challenging problems may accordingly be enhanced.

Experimental results for the transformer network 20 are discussed below. In the experiments discussed below, the transformer network 20 was a machine translation model, and the performance of the transformer network 20 (referred to below as DeepNet) was tested against that of other transformer architectures that do not utilize the scaling parameters discussed above. In a first set of experiments, the transformer models were tested on German-to-English and English-to-German translation tasks using the IWSLT-14 German-English (De-En) dataset and the WMT-17 English-German (En-De) dataset. The other transformer architectures tested in the first experiment were vanilla post-LN, vanilla pre-LN, DLCL, NormFormer, ReZero, R-Fixup, T-Fixup, Ds-Init, and Admin. These other architectures include transformer architectures that use pre-LN, post-LN, and no LN. Bilingual evaluation understudy (BLEU) was the evaluation metric used for each of the transformer architectures.

The following hyperparameters were used for each of the models in the first set of experiments when the transformer models were trained for German-to-English translation:

| Hyperparameter | Value |
|---|---|
| Learning rate | 5e−4 |
| Learning rate scheduler | Inverse sqrt |
| Warm-up updates | 4000 |
| Warm-up initial learning rate | 1e−7 |
| Max tokens | 4000 |
| Adam ϵ | 1e−8 |
| Adam β | (0.9, 0.98) |
| Label smoothing | 0.1 |
| Training updates | 8K |
| Gradient clipping | 0.0 |
| Dropout | 0.4 |
| Weight decay | 0.0001 |
| Hidden size | 512 |
| FFN inner hidden size | 2048 |
| Attention heads | 8 |

The following hyperparameters were used for each of the models in the first experiment when the transformer models were trained for English-to-German translation:

| Hyper- | Value | Value (Pre- | Value | Value |
|---|---|---|---|---|
| parameter | (No-LN) | LN) | (Post-LN) | (DeepNorm) |
| Learning rate | 5e−4 | 1.5e−3 | 1.5e−3 | 1.5e−3 |
| Learning rate | Inverse sqrt | Inverse sqrt | Inverse sqrt | Inverse sqrt |
| scheduler | | | | |
| Warm-up | 4000 | 4000 | 4000 | 4000 |
| updates | | | | |
| Warm-up | 1e−7 | 1e−7 | 1e−7 | 1e−7 |
| initial learning | | | | |
| rate | | | | |
| Max tokens | 128 × 4096 | 128 × 4096 | 128 × 4096 | 128 × 4096 |
| Adam ϵ | 1e−8 | 1e−8 | 1e−8 | 1e−8 |
| Adam β | (0.9, 0.98) | (0.9, 0.98) | (0.9, 0.98) | (0.9, 0.98) |
| Label | 0.1 | 0.1 | 0.1 | 0.1 |
| smoothing | | | | |
| Training | 100K | 100K | 100K | 100K |
| updates | | | | |
| Gradient | 0.0 | 0.0 | 0.0 | 0.0 |
| clipping | | | | |
| Dropout | 0.4 | 0.4 | 0.4 | 0.4 |
| Weight decay | 0.0001 | 0.0001 | 0.0001 | 0.0001 |
| Hidden size | 512 | 512 | 512 | 512 |
| FFN inner | 2048 | 2048 | 2048 | 2048 |
| hidden size | | | | |
| Attention heads | 8 | 8 | 8 | 8 |

The transformer models trained to perform the English-to-German translation task were encoder-decoder transformer models and were trained at four different sizes: 6 L-6 L, 18 L-18 L, 50 L-50 L, and 100 L-100 L, where AL-BL refers to an A-layer encoder and a B-layer decoder. The following table shows the performance of each of the models at the English-to-German translation task. The entries of following table are BLEU values given as percentages. The architectures are grouped according to the type of normalization they use, where DeepNorm is the normalization performed at the normalization sub-layers 26 of the transformer network 20 discussed above (DeepNet).

| Model | LN | 6L-6L | 18L-18L | 50L-50L | 100L-100L |
|---|---|---|---|---|---|
| Vanilla | Post | 28.1 | — | Diverged | — |
| post-LN | | | | | |
| DS-Init | Post | 27.9 | — | Diverged | — |
| Admin | Post | 27.9 | 28.8 | Diverged | — |
| ReZero | No | 26.9 | — | Diverged | — |
| R-Fixup | No | 27.5 | 28.4 | 27.7 | Diverged |
| T-Fixup | No | 27.5 | 28.4 | 27.9 | Diverged |
| Vanilla pre- | Pre | 27.0 | 28.1 | 28.0 | 27.4 |
| LN | | | | | |
| DLCL | Pre | 27.4 | 28.2 | Diverged | 27.5 |
| Normformer | Pre | 27.0 | 28.3 | 27.8 | Diverged |
| DeepNet | Deep | 27.8 | 28.8 | 29.0 | 28.9 |

Compared with the models with Post-LN, as shown in the above table, DeepNet is more stable at high layer counts. DeepNet also achieves comparable performance with such models at low model depths. Compared to the architectures that do not utilize layer normalization, DeepNet achieves higher translation accuracy and does not drop in performance at high depths. The models that utilize pre-LN typically remain stable at higher depths than the models that utilize post-LN or no LN. However, due to having gradients at lower layers that are larger than the gradients at higher layers, pre-LN models achieve lower BLEU values than converged post-LN models. DeepNet avoids the above problem with pre-LN models by using post-LN while also remaining stable at high depths.

The transformer models were also tested for convergence on the German-to-English translation task for model depths ranging from 10 L-10 L to 100 L-100 L in increments of 10 layers. Mixed-precision training was used for each of the architectures except ReZero. The models were each trained for 8000 steps. DeepNet remains stable across the entire range of tested depths and converges to over 30% BLEU within the 8000 steps. DeepNet also exhibits increased performance as model depth increases. In contrast, the post-LN models all diverge at high depths. Of the no-LN models, T-Fixup diverges, whereas R-Fixup and ReZero converge to lower BLEU scores than DeepNet. Of the Pre-LN models, vanilla Pre-LN diverges at high depths, DLCL converges to a lower BLEU score than DeepNet, and NormFormer exhibits decreasing BLEU scores with increasing depth.

In a second set of experiments, DeepNet was scaled to increased learning rates, batch sizes, and hidden dimensions, respectively. Each of the above hyperparameters was changed while leaving the other hyperparameters fixed. The values of the learning rate were 5e-4, 1e-3, and 1.5e-3. The values of the batch size were 64×4K, 128×4K, and 256×4K. The values of the hidden dimensions were (512, 2048, 8), (768, 3072, 12), and (1024, 4096, 16), where the elements of these triples respectively indicate the hidden size, the FFN inner hidden size, and the number of attention heads. The following table lists the values of the hyperparameters were used in the hidden dimension scaling experiments:

| | | Value (medium | |
|---|---|---|---|
| Hyperparameter | Value (base size) | size) | Value (large size) |
| Hidden size | 512 | 768 | 1024 |
| FFN inner hidden | 2048 | 3072 | 4096 |
| size | | | |
| Attention heads | 8 | 12 | 16 |
| Layers | 18-18 | 18-18 | 18-18 |
| Learning rate | 5e−4 | 5e−4 | 5e−4 |
| Learning rate | Inverse sqrt | Inverse sqrt | Inverse sqrt |
| scheduler | | | |
| Warm-up updates | 4000 | 4000 | 4000 |
| Warm-up initial | 1e−7 | 1e−7 | 1e−7 |
| learning rate | | | |
| Max tokens | 128 × 4096 | 128 × 4096 | 128 × 4096 |
| Adam ϵ | 1e−6 | 1e−6 | 1e−6 |
| Adam β | (0.9, 0.98) | (0.9, 0.98) | (0.9, 0.98) |
| Label smoothing | 0.1 | 0.1 | 0.1 |
| Training updates | 30K | 30K | 30K |
| Gradient clipping | 1.0 | 1.0 | 1.0 |
| Dropout | 0.4 | 0.4 | 0.4 |
| Weight decay | 0.0 | 0.0 | 0.0 |

In each of the above experiments, the models were trained for 30,000 iterations. The loss decreased over the 30,000 iterations for each of the tested sets of hyperparameters, except for hidden dimensions (1024, 4096, 16), at which overfitting occurred after approximately 10,000 steps.

In another set of experiments, the DeepNet architecture was trained on multilingual neural machine translation (NMT) tasks. Each of the translation tasks was translation to or from English. The OPUS-100 corpus was used to train respective encoder-decoder DeepNet models including 200 and 1000 layers, with equal numbers of encoder layers and decoder layers. Baseline multilingual NMT transformer models with 12, 24, and 48 layers, respectively, were also trained on the OPUS-100 dataset. The following hyperparameters were used for the DeepNet models and the baseline multilingual NMT transformer models:

| Hyperparameter | Value |
|---|---|
| Learning rate | 5e−4 |
| Learning rate scheduler | Inverse sqrt |
| Warm-up updates | 4000 |
| Warm-up initial learning rate | 1e−7 |
| Max tokens | 128 × 4096 |
| Adam ϵ | 1e−8 |
| Adam β | (0.9, 0.98) |
| Label smoothing | 0.1 |
| Training epochs | 4 |
| Gradient clipping | 0.0 |
| Dropout | 0.1 |
| Weight decay | 0.0 |
| Hidden size | 512 |
| FFN inner hidden size | 2048 |
| Attention heads | 8 |

The following table shows the results of the multilingual NMT experiment. The table shows BLEU values given as percentages.

| Model | #Layers | #Parameters | X→En | En→X | Avg. |
|---|---|---|---|---|---|
| Baseline | 12 | 133M | 27.5 | 21.4 | 24.5 |
| | 24 | 173M | 29.5 | 22.9 | 26.2 |
| | 48 | 254M | 31.4 | 24.0 | 27.7 |
| DeepNet | 200 | 863M | 33.2 | 29.0 | 31.1 |
| | 1000 | 3.8 B | 33.9 | 30.2 | 32.1 |

As shown in the above table, the 1000-layer DeepNet model outperforms the 48-layer baseline model by 4.4 percentage points.

DeepNet models with {12, 20, 100, 200, 1000} layers were trained on the OPUS-100 dataset. The BLEU score of the DeepNet models approximately followed a scaling law given by:

$$L ( d ) = A log ( d ) + B$$

where L is the BLEU score, d is the depth of the model, and A and B are constants determined by the other hyperparameters.

In another experiment, a DeepNet model was trained to perform multilingual NMT using a dataset of 102 languages, 1932 translation directions, and 12B sentence pairs. The DeepNet model was trained with and 100-layer encoder, a 100-layer decoder, 1024 hidden dimensions, 16 attention heads, and 4096 intermediate FFN-layer dimensions. The following hyperparameters were used:

| Hyperparameter | Value |
|---|---|
| Learning rate | 5e−4 |
| Learning rate scheduler | Inverse sqrt |
| Warm-up updates | 6000 |
| Warm-up initial learning rate | 1e−7 |
| Max tokens | 256 × 4096 |
| Adam ϵ | 1e−6 |
| Adam β | (0.9, 0.98) |
| Label smoothing | 0.1 |
| Training updates | 260K |
| Gradient clipping | 1.0 |
| Dropout | 0.1 |
| Weight decay | 0.0 |
| Hidden size | 1024 |
| FFN inner hidden size | 4096 |
| Attention heads | 16 |
| Layers | 100-100 |

In the 102-language multilingual NMT experiment, the baseline model was M2M-100, which has a 24-layer encoder, a 24-layer decoder, and a hidden size of 4096, resulting in up to 12B parameters. In contrast, the DeepNet model includes approximately 3.2B parameters. The DeepNet model was generated with a beam size of 5 and a length penalty of 1.

The DeepNet model and the M2M-100 model were evaluated on the WMT, OPUS, TED, and Flores datasets. The two models were compared on 87 languages and 7482 translation directions shared by both DeepNet and M2M-100. The following table compares the BLEU scores of DeepNet and M2M-100:

| Model | #Layers | #Params. | WMT | OPUS | TED | Flores |
|---|---|---|---|---|---|---|
| M2M-100 | 48 | 12B | 31.9 | 18.4 | 18.7 | 13.6 |
| DeepNet | 200 | 3.2B | 33.9 | 23.0 | 20.1 | 18.6 |

As shown in the above table, DeepNet achieves higher BLEU values than M2M-100 despite including significantly fewer parameters.

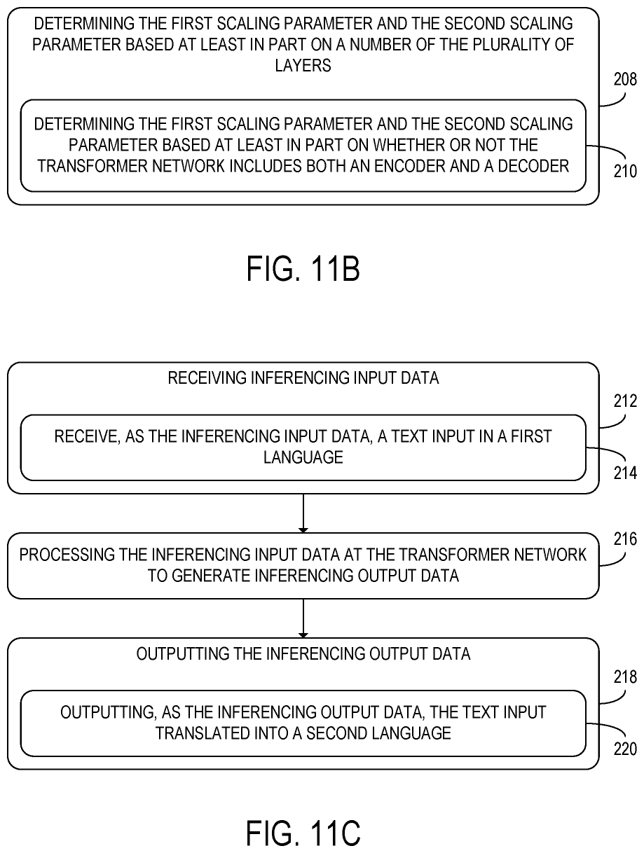

Turning now to FIG. 11A, a flowchart of a method 200 for use with a computing system is shown. The method 200 may, for example, be used with the computing system 10 of FIG. 1. At step 202, the method 200 includes receiving a training data set. The training data set may include a plurality of training tokens.

At step 204, the method 200 further includes training a transformer network that includes a plurality of layers based at least in part on the training data set. In some examples, the transformer network includes 100 or more layers. The transformer network may, for example, include 200, 500, or 1000 layers in examples in which the transformer network includes over 100 layers.

The plurality of layers each respectively include a plurality of sub-layers including an attention sub-layer, a feed-forward sub-layer, and a plurality of normalization sub-layers. When the layer is a decoder layer, the layer may further include a masked attention sub-layer prior to the attention sub-layer. The plurality of normalization sub-layers are located downstream from corresponding sub-layers of the plurality of sub-layers. Thus, respective normalization sub-layers may be included in the layer after the attention sub-layer, the feed-forward sub-layer, and (when included) the masked attention sub-layer. Each of the plurality of normalization sub-layers is configured to apply layer normalization to a sum of: a first scaling parameter multiplied by an input vector of the sub-layer; and an output vector of the sub-layer. Accordingly, the residual copy of the input vector is scaled by the first scaling parameter.

In some examples, at step 206, training the transformer network at step 204 further includes, during an initialization phase, scaling a plurality of value projection weights and a plurality of output projection weights of the attention sub-layer and a plurality of feed-forward weights of the feed-forward sub-layer by a second scaling parameter. This scaling increases the stability of the transformer network during training.

Training the transformer network at step 204 includes performing a warm-up phase and a main training phase in some examples. During the warm-up phase, the learning rate of the transformer network is gradually increased until it reaches the value of the learning rate used in the main training phase. The warm-up phase makes the transformer network less likely to become stuck in a spurious local optimum early in training.

FIG. 11B shows additional steps of the method 200 that may be performed in examples in which step 206 is performed. At step 208, the method 200 may further include determining the first scaling parameter and the second scaling parameter based at least in part on a number of the plurality of layers included in the transformer network. In addition, the transformer network includes an encoder and/or a decoder.

At step 210, determining the values of the scaling parameters at step 208 may further include determining the first scaling parameter and the second scaling parameter based at least in part on whether or not the transformer network includes both an encoder and a decoder. In examples in which the transformer network includes the encoder without including the decoder or includes the decoder without including the encoder, the first scaling parameter may be equal to

$${( 2 N )}^{\frac{1}{4}} ,$$

where N is the number of the plurality of layers. In such examples, the second scaling parameter may be equal to

$${( 8 N )}^{- \frac{1}{4}} .$$

In examples in which the transformer network includes both the encoder and the decoder, the first scaling parameter and the second scaling parameter may differ between the encoder and the decoder. At the encoder, the first scaling parameter may be equal to

$$0.81 {( {N}^{4} M )}^{\frac{1}{16}} ,$$

where N is a number of encoder layers included in the encoder and M is a number of decoder layers included in the decoder. The second scaling parameter at the encoder may be equal to

$$0.87 {( {N}^{4} M )}^{\frac{- 1}{16}} .$$

At the decoder, the first scaling parameter may be equal to

$${( 3 M )}^{\frac{1}{4}}$$

and the second scaling parameter may be equal to

$${( 12 M )}^{\frac{- 1}{4}} .$$

FIG. 11C shows additional steps of the method 200 that may be performed at inferencing time subsequently to training the transformer network. At step 212, the method 200 may further include receiving inferencing input data. The inferencing input data may include one or more inferencing input tokens. In some examples, the transformer network is a machine translation model. In such examples, at step 214, receiving the inferencing input data at step 212 may include receiving, as the inferencing input data, a text input in a first language.

At step 216, the method 200 may further include processing the inferencing input data at the transformer network to generate inferencing output data. At step 218, the method 200 may further include outputting the inferencing output data. In examples in which the transformer network is a machine translation model, at step 220, step 218 may include outputting, as the inferencing output data, the text input translated into a second language. Thus, the transformer network is configured to perform machine translation.

In some embodiments, the methods and processes described herein may be tied to a computing system of one or more computing devices. In particular, such methods and processes may be implemented as a computer-application program or service, an application-programming interface (API), a library, and/or other computer-program product.

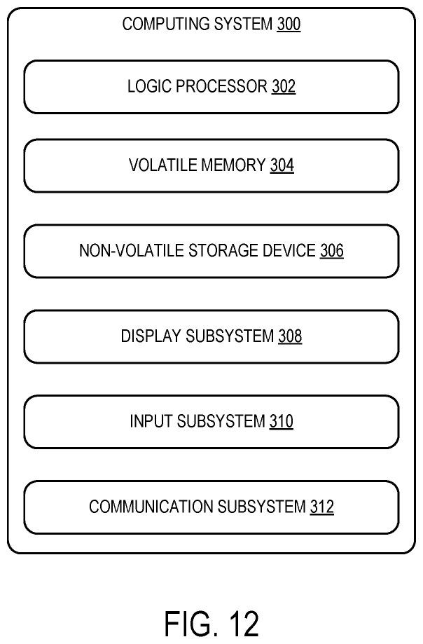

FIG. 12 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be instantiated in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display subsystem 308, input subsystem 310, communication subsystem 312, and/or other components not shown in FIG. 12.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 302 may include one or more physical processors configured to execute software instructions. Additionally or alternatively, the logic processor may include one or more hardware logic circuits or firmware devices configured to execute hardware-implemented logic or firmware instructions. For example, the logic processor 302 may include one or more graphics processing units (GPUs) and/or other hardware accelerators. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built-in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 300 to send and/or receive messages to and/or from other devices via a network such as the Internet.

The following paragraphs discuss several aspects of the present disclosure. According to one aspect of the present disclosure, a computing system is provided, including a processor configured to receive a training data set. Based at least in part on the training data set, the processor is further configured to train a transformer network that includes a plurality of layers. The plurality of layers each respectively include a plurality of sub-layers including an attention sub-layer, a feed-forward sub-layer, and a plurality of normalization sub-layers downstream from corresponding sub-layers of the plurality of sub-layers. Each of the plurality of normalization sub-layers is configured to apply layer normalization to a sum of: a first scaling parameter multiplied by an input vector of the sub-layer; and an output vector of the sub-layer. The above features may have the technical effect of allowing stable training of the transformer network at high depths.

According to this aspect, at each of the plurality of layers, the processor may be further configured to scale a plurality of value projection weights and a plurality of output projection weights of the attention sub-layer and a plurality of feed-forward weights of the feed-forward sub-layer by a second scaling parameter when training the transformer network. The above features may have the technical effect of increasing the stability of the transformer network during training.

According to this aspect, the processor may be further configured to determine the first scaling parameter and the second scaling parameter based at least in part on a number of the plurality of layers. The above features may have the technical effect of selecting values of the first scaling parameter and the second scaling parameter that allow for stable training.

According to this aspect, the transformer network may include an encoder and/or a decoder. The processor may be further configured to determine the first scaling parameter and the second scaling parameter based at least in part on whether or not the transformer network includes both an encoder and a decoder. The above features may have the technical effect of selecting values of the first scaling parameter and the second scaling parameter in an architecture-dependent manner.

According to this aspect, the transformer network may include the encoder without including the decoder or include the decoder without including the encoder. The first scaling parameter may be equal to

$${( 2 N )}^{\frac{1}{4}} ,$$

where N is the number of the plurality of layers. The second scaling parameter may be equal to

$${( 8 N )}^{- \frac{1}{4}} .$$

The above features may have the technical effect of selecting values of the first scaling parameter and the second scaling parameter that allow for stable training.

According to this aspect, the transformer network includes both the encoder and the decoder. The first scaling parameter and the second scaling parameter may differ between the encoder and the decoder. The above features may have the technical effect of accounting for differences in layer structure between the encoder and decoder when selecting the values of the first scaling parameter and the second scaling parameter.

According to this aspect, at the encoder, the first scaling parameter may be equal to

$$0.81 {( {N}^{4} M )}^{\frac{1}{16}} ,$$

where N is a number of encoder layers included in the encoder and M is a number of decoder layers included in the decoder, and the second scaling parameter may be equal to

$$0.87 {( {N}^{4} M )}^{\frac{- 1}{16}} .$$

At the decoder, the first scaling parameter may be equal to

$${( 3 M )}^{\frac{1}{4}}$$

and the second scaling parameter may be equal to

$${( 12 M )}^{\frac{- 1}{4}} .$$

The above features may have the technical effect of selecting values of the first scaling parameter and the second scaling parameter that allow for stable training.

According to this aspect, the transformer network includes 100 or more layers. The above features may have the technical effect of allowing the transformer network to model complex patterns in its training data.

According to this aspect, the transformer network is a machine translation model. The above features may have the technical effect of allowing users to use the transformer network for natural language translation.

According to another aspect of the present disclosure, a method for use with a computing system is provided. The method includes receiving a training data set. Based at least in part on the training data set, the method further includes training a transformer network that includes a plurality of layers. The plurality of layers each respectively include a plurality of sub-layers including an attention sub-layer, a feed-forward sub-layer, and a plurality of normalization sub-layers downstream from corresponding sub-layers of the plurality of sub-layers. Each of the plurality of normalization sub-layers is configured to apply layer normalization to a sum of: a first scaling parameter multiplied by an input vector of the sub-layer; and an output vector of the sub-layer. The above features may have the technical effect of allowing stable training of the transformer network at high depths.

According to this aspect, at each of the plurality of layers, training the transformer network may further include scaling a plurality of value projection weights and a plurality of output projection weights of the attention sub-layer and a plurality of feed-forward weights of the feed-forward sub-layer by a second scaling parameter. The above features may have the technical effect of increasing the stability of the transformer network during training.

According to this aspect, training the transformer network may further include determining the first scaling parameter and the second scaling parameter based at least in part on a number of the plurality of layers. The above features may have the technical effect of selecting values of the first scaling parameter and the second scaling parameter that allow for stable training.

According to this aspect, the transformer network may include an encoder and/or a decoder. Training the transformer network may further include determining the first scaling parameter and the second scaling parameter based at least in part on whether or not the transformer network includes both an encoder and a decoder. The above features may have the technical effect of selecting values of the first scaling parameter and the second scaling parameter in an architecture-dependent manner.

According to this aspect, the transformer network may include the encoder without including the decoder or include the decoder without including the encoder. The first scaling parameter may be equal to

$${( 2 N )}^{\frac{1}{4}} ,$$

where N is the number of the plurality of layers. The second scaling parameter may be equal to

$${( 8 N )}^{- \frac{1}{4}} .$$

The above features may have the technical effect of selecting values of the first scaling parameter and the second scaling parameter that allow for stable training.

According to this aspect, the transformer network may include both the encoder and the decoder. The first scaling parameter and the second scaling parameter may differ between the encoder and the decoder. The above features may have the technical effect of accounting for differences in layer structure between the encoder and decoder when selecting the values of the first scaling parameter and the second scaling parameter.

According to this aspect, at the encoder, the first scaling parameter may be equal to

$$0.81 {( {N}^{4} M )}^{\frac{1}{16}} ,$$

where N is a number of encoder layers included in the encoder and M is a number of decoder layers included in the decoder, and the second scaling parameter is equal to

$$0.87 {( {N}^{4} M )}^{\frac{- 1}{16}} .$$

At the decoder, the first scaling parameter may be equal to

$${( 3 M )}^{\frac{1}{4}}$$

and the second scaling parameter is equal to

$${( 12 M )}^{\frac{- 1}{4}} .$$

The above features may have the technical effect of selecting values of the first scaling parameter and the second scaling parameter that allow for stable training.

According to this aspect, the transformer network may include 100 or more layers. The above features may have the technical effect of allowing the transformer network to model complex patterns in its training data.

According to this aspect, the transformer network may be a machine translation model. The above features may have the technical effect of allowing users to use the transformer network for natural language translation.

According to another aspect of the present disclosure, a computing system is provided, including a processor configured to receive inferencing input data. The processor is further configured to process the inferencing input data at a transformer network to generate inferencing output data. The transformer network includes a plurality of layers that each respectively include a plurality of sub-layers including an attention sub-layer, a feed-forward sub-layer, and a plurality of normalization sub-layers downstream from corresponding sub-layers of the plurality of sub-layers. Each of the plurality of normalization sub-layers is configured to apply layer normalization to a sum of: a first scaling parameter multiplied by an input vector of the sub-layer; and an output vector of the sub-layer. The processor is further configured to output the inferencing output data. The above features may have the technical effect of performing inferencing at a high-depth transformer network that has been stably trained, thereby allowing the transformer network to model complex patterns in its training data.

According to this aspect, the transformer network may be a machine translation model configured to receive, as the inferencing input data, a text input in a first language. The processor may be further configured to output, as the inferencing output data, the text input translated into a second language. The above features may have the technical effect of allowing users to use the transformer network for natural language translation.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
a processor configured to:
receive a training data set; and
based at least in part on the training data set, train a transformer network that includes a plurality of layers, wherein the plurality of layers each respectively include a plurality of sub-layers including:
an attention sub-layer;
a feed-forward sub-layer; and
a plurality of normalization sub-layers downstream from corresponding sub-layers of the plurality of sub-layers, wherein each of the plurality of normalization sub-layers is configured to apply layer normalization to a sum of:
a first scaling parameter multiplied by an input vector of the sub-layer; and
an output vector of the sub-layer.

2. The computing system of claim 1, wherein, at each of the plurality of layers, the processor is further configured to scale a plurality of value projection weights and a plurality of output projection weights of the attention sub-layer and a plurality of feed-forward weights of the feed-forward sub-layer by a second scaling parameter when training the transformer network.

3. The computing system of claim 2, wherein the processor is further configured to determine the first scaling parameter and the second scaling parameter based at least in part on a number of the plurality of layers.

4. The computing system of claim 3, wherein:
the transformer network includes an encoder and/or a decoder; and
the processor is further configured to determine the first scaling parameter and the second scaling parameter based at least in part on whether or not the transformer network includes both an encoder and a decoder.

5. The computing system of claim 4, wherein:
the transformer network includes the encoder without including the decoder or includes the decoder without including the encoder;
the first scaling parameter is equal to
$${( 2 N )}^{\frac{1}{4}} ,$$
where N is the number of the plurality of layers; and
the second scaling parameter is equal to
$${( 8 N )}^{- \frac{1}{4}} .$$

6. The computing system of claim 4, wherein:
the transformer network includes both the encoder and the decoder; and
the first scaling parameter and the second scaling parameter differ between the encoder and the decoder.

7. The computing system of claim 6, wherein:
at the encoder:
the first scaling parameter is equal to
$$0.81 {( {N}^{4} M )}^{\frac{1}{16}} ,$$
where N is a number of encoder layers included in the encoder and M is a number of decoder layers included in the decoder; and
the second scaling parameter is equal to
$$0.87 {( {N}^{4} M )}^{\frac{- 1}{16}} ;$$
and at the decoder:
the first scaling parameter is equal to
$${( 3 M )}^{\frac{1}{4}} ;$$
and
the second scaling parameter is equal to
$${( 12 M )}^{\frac{- 1}{4}} .$$

8. The computing system of claim 1, wherein the transformer network includes 100 or more layers.

9. The computing system of claim 1, wherein the transformer network is a machine translation model.

10. A method for use with a computing system, the method comprising:
receiving a training data set; and
based at least in part on the training data set, training a transformer network that includes a plurality of layers, wherein the plurality of layers each respectively include a plurality of sub-layers including:
an attention sub-layer;
a feed-forward sub-layer; and
a plurality of normalization sub-layers downstream from corresponding sub-layers of the plurality of sub-layers, wherein each of the plurality of normalization sub-layers is configured to apply layer normalization to a sum of:
a first scaling parameter multiplied by an input vector of the sub-layer; and
an output vector of the sub-layer.

11. The method of claim 10, wherein, at each of the plurality of layers, training the transformer network further includes scaling a plurality of value projection weights and a plurality of output projection weights of the attention sub-layer and a plurality of feed-forward weights of the feed-forward sub-layer by a second scaling parameter.

12. The method of claim 11, wherein training the transformer network further includes determining the first scaling parameter and the second scaling parameter based at least in part on a number of the plurality of layers.

13. The method of claim 12, wherein:
the transformer network includes an encoder and/or a decoder; and
training the transformer network further includes determining the first scaling parameter and the second scaling parameter based at least in part on whether or not the transformer network includes both an encoder and a decoder.

14. The method of claim 13, wherein:
the transformer network includes the encoder without including the decoder or includes the decoder without including the encoder;
the first scaling parameter is equal to
$${( 2 N )}^{\frac{1}{4}} ,$$
where N is the number of the plurality of layers; and
the second scaling parameter is equal to
$${( 8 N )}^{- \frac{1}{4}} .$$

15. The method of claim 13, wherein:
the transformer network includes both the encoder and the decoder; and
the first scaling parameter and the second scaling parameter differ between the encoder and the decoder.

16. The method of claim 15, wherein:
at the encoder:
the first scaling parameter is equal to
$$0.81 {( {N}^{4} M )}^{\frac{1}{16}} ,$$
where N is a number of encoder layers included in the encoder and M is a number of decoder layers included in the decoder; and
the second scaling parameter is equal to
$$0.87 {( {N}^{4} M )}^{\frac{- 1}{16}} ;$$
and at the decoder:
the first scaling parameter is equal to
$${( 3 M )}^{\frac{1}{4}} ;$$
and
the second scaling parameter is equal to
$${( 12 M )}^{\frac{- 1}{4}} .$$

17. The method of claim 10, wherein the transformer network includes 100 or more layers.

18. The method of claim 10, wherein the transformer network is a machine translation model.

19. A computing system comprising:
a processor configured to:
receive inferencing input data;
process the inferencing input data at a transformer network to generate inferencing output data, wherein the transformer network includes a plurality of layers that each respectively include a plurality of sub-layers including:
an attention sub-layer;
a feed-forward sub-layer; and
a plurality of normalization sub-layers downstream from corresponding sub-layers of the plurality of sub-layers, wherein each of the plurality of normalization sub-layers is configured to apply layer normalization to a sum of:
a first scaling parameter multiplied by an input vector of the sub-layer; and
an output vector of the sub-layer; and
output the inferencing output data.

20. The computing system of claim 19, wherein the transformer network is a machine translation model configured to:
receive, as the inferencing input data, a text input in a first language; and
output, as the inferencing output data, the text input translated into a second language.
